(19) United States
(12) Patent Application Publication
(10) Pub. No.: US 2026/0197343 A1
(43) Pub. Date: Jul. 9, 2026

(54) VEHICLE DATA SPOOFING DETECTION AND MITIGATION

(71) Applicant: Ford Global Technologies, LLC, Dearborn, MI (US)

(72) Inventors: Anuj Pal, St. Paul, MN (US); David Michael Herman, West Bloomfield, MI (US); Colleen Hummel, Northville, MI (US)

(21) Appl. No.: 19/015,050

(22) Filed: Jan. 9, 2025

(51) Int. Cl. H04L 9/40; G01R 31/00; G01R 31/28; G07C 5/00

(52) U.S. Cl. CPC H04L 63/1466; G01R 31/007; G01R 31/2829; G07C 5/008

(57) ABSTRACT

Validating vehicle signal integrity is performed. Combined signals including sensor signals and reference signals are received from a telematics control unit (TCU) of a vehicle. The reference signals are extracted from the combined signals based on a predefined timing pattern known to the server. A reference output is generated by processing predefined reference signals using an analysis model. A test output is generated by processing the extracted reference signals using the analysis model. An error signal is calculated as a difference between the reference output and the test output. The error signal is compared to a predefined threshold to determine whether a spoofing condition exists. A data select command is transmitted to the vehicle responsive to determining the spoofing condition to mitigate unreliable signals.

### TECHNICAL FIELD

Aspects of the disclosure generally relate to identifying and addressing data spoofing in the collection and analysis of vehicle data.

### BACKGROUND

Connected vehicles may send data to a cloud system. Usage-based insurance (UBI) is a type of vehicle insurance whereby the premium cost is dependent on the driving behavior of a driver. A UBI device may be connected to a vehicle network via a connector such as an on-board diagnostic II (OBD-II) port to collect vehicle operating data and send the data to a remote server for analysis. In other examples, a telematics control unit (TCU) of the vehicle may collect the vehicle operating data and send the data to the remote server for analysis.

### SUMMARY

In one or more illustrative examples, a method for validating vehicle signal integrity using a cloud server includes receiving, from a telematics control unit (TCU) of a vehicle, combined signals comprising sensor signals and reference signals; extracting the reference signals from the combined signals based on a predefined timing pattern known to the server; generating a reference output by processing predefined reference signals using an analysis model; generating a test output by processing the extracted reference signals using the analysis model; calculating an error signal as a difference between the reference output and the test output; comparing the error signal to a predefined threshold to determine whether a spoofing condition exists; and transmitting a data select command to the vehicle responsive to determining the spoofing condition to mitigate unreliable signals.

In one or more illustrative examples, the method further includes precomputing and storing the reference output for subsequent comparison.

In one or more illustrative examples, the predefined reference signals are generated using a statistical model incorporating predefined characteristics of the sensor signals, including temporal patterns and/or environmental variations of the sensor signals.

In one or more illustrative examples, the combined signals are received wirelessly over a wide-area communication network, and the predefined reference signals are received locally over a diagnostic interface between the cloud server and the vehicle.

In one or more illustrative examples, the method further includes analyzing diagnostic trouble codes (DTCs) extracted from the combined signals to differentiate between the spoofing condition and a sensor issue.

In one or more illustrative examples, the method further includes performing iteratively replacing individual sensor signals in the combined signals when generating the test output to identify specific corrupted signals.

In one or more illustrative examples, transmitting the data select command includes reconfiguring the TCU to exclude identified spoofed signals from subsequent combined signals.

In one or more illustrative examples, the method further includes generating validity estimates over time based on periodic verification of the predefined reference signals to detect intermittent spoofing conditions.

In one or more illustrative examples, the reference output and the test output are vector representations, and the error signal is a subtraction of the vector representations resulting in a scalar output to compare to a scalar predefined threshold.

In one or more illustrative examples, the analysis model is one or more of a usage-based insurance (UBI) analysis model configured to predict UBI metrics for determining of UBI; or a maintenance analysis model configured to predict maintenance metrics for determining when to perform vehicle maintenance.

In one or more illustrative examples, a vehicle includes one or more vehicle controllers and sensors; and one or more processors configured to collect sensor signals from the one or more vehicle controllers and sensors via a vehicle bus of the vehicle, combine the sensor signals and reference signals into first combined signals based on a predefined timing pattern, transmit the combined signals to a cloud server over a communication network, receive a data select command from the cloud server specifying adjustments to the combined signals, and collect second combined signals to be sent subsequent to the first combined signals, based on the adjustments received in the data select command.

In one or more illustrative examples, the reference signals are generated using a statistical model incorporating predefined characteristics of the sensor signals, including temporal patterns and/or environmental variations of the sensor signals.

In one or more illustrative examples, the one or more processors are further configured to perform a local verification of the first combined signals using a reduced analysis model to generate an error signal indicating potential spoofing conditions.

In one or more illustrative examples, performing the local verification includes iteratively replacing individual sensor signals with the reference signals to identify specific corrupted signals.

In one or more illustrative examples, to collect the sensor signals includes to maintain a mapping of controllers and associated vehicle buses to retrieve the sensor signals from the one or more vehicle controllers and sensors.

In one or more illustrative examples, the one or more processors are further configured to encrypt the first combined signals before transmission to ensure data integrity over the communication network.

In one or more illustrative examples, a cloud server for validating vehicle signal integrity includes a storage configured to maintain predefined reference signals and a predefined timing pattern; and one or more processors configured to receive, from a vehicle, combined signals comprising sensor signals and test reference signals, extract the test reference signals from the combined signals based on the predefined timing pattern, generate a reference output by processing the predefined reference signals using an analysis model, generate a test output by processing the test reference signals using the analysis model, calculate an error signal as a difference between the reference output and the test output, compare the error signal to a predefined threshold to determine whether a spoofing condition exists, and transmit a data select command to the vehicle responsive to determining the spoofing condition to mitigate unreliable signals.

In one or more illustrative examples, wherein the one or more processors are further configured to analyze DTCs extracted from the combined signals to differentiate between the spoofing condition and a sensor issue.

In one or more illustrative examples, wherein the one or more processors are further configured to perform iteratively replacing individual sensor signals in the combined signals when generating the test output to identify specific corrupted signals.

In one or more illustrative examples, wherein the one or more processors are further configured to specify, in the data select command, a reconfiguration of the vehicle to exclude identified spoofed signals from subsequent combined signals.

In one or more illustrative examples, wherein the one or more processors are further configured to generate validity estimates over time based on periodic verification of the predefined reference signals to detect intermittent spoofing conditions.

### BRIEF DESCRIPTION OF THE DRAWINGS

FIG. 1 illustrates an example system for identifying and addressing data spoofing in the collection and analysis of vehicle data;

FIG. 2 illustrates an example data flow for the operation of the system to detect spoofed signals;

FIG. 3A illustrates an example of a first type of verification of the combined signals that may be performed by the cloud server;

FIG. 3B illustrates an example of a second type of verification of the combined signals that may be performed by the cloud server to account for diagnostic trouble codes (DTCs);

FIG. 3C illustrates an example of a second type of verification of the combined signals that may be performed locally by the vehicle using the iterator component;

FIG. 3D illustrates an example of a fourth type of verification of the combined signals that may be performed by the cloud server using the iterator component;

FIG. 4A illustrates an example of performing the verifications over time to determine validity estimates over time;

FIG. 4B illustrates an alternate example of performing the verifications over time to determine validity estimates over time;

FIG. 5 illustrates an example process for validating the integrity of vehicle signals using the cloud server;

FIG. 6 illustrates an example process for generating and transmitting validated vehicle data using a TCU or other processing components of a vehicle; and

FIG. 7 illustrates an example computing device for use in identifying and addressing data spoofing in the collection and analysis of vehicle data.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Analysis models that determine the behavior of the vehicles may rely on vehicle signals. However, alteration of those vehicle signals by an end user may cause the analysis models to produce inaccurate results. Some example alterations include supplying vehicle data bus signals with fake data, disconnecting location equipment such as global navigation satellite system (GNSS) receivers, hiding or obscuring cameras used to detect eye tracking, and selectively turning off data sharing before performing certain maneuvers. It should be noted that these are only examples, and other methods of spoofing or otherwise manipulating vehicle data and/or aggregation metrics based on vehicle data are possible and considered in the context of the present disclosure. For instance, identity and related data signals may also be spoofed in certain cases (e.g., phone as a key, face as a key, vehicle password, etc.).

Aspects of the disclosure provide an approach that identifies and addresses data spoofing in the collection and analysis of data by analysis models. The approach may include generating or reusing reference signal data by a vehicle and passing the reference signal through a data route to a cloud server. The analysis model may process a stored reference signal as an input to determine a reference output. The analysis model may also be evaluated using the received reference signal data from the vehicle to determine a test output. If the data is intact, a delta between the test output and the reference output will be zero or very small. If the data has been spoofed, the delta will be higher. If spoofed data is detected, remediation may be performed to continue to allow the analysis model to function. This approach may be applicable to various types of analysis, such as models for use in determining UBI and/or for use in determining vehicle wear or need for servicing. Further aspects of the disclosure are discussed in detail here.

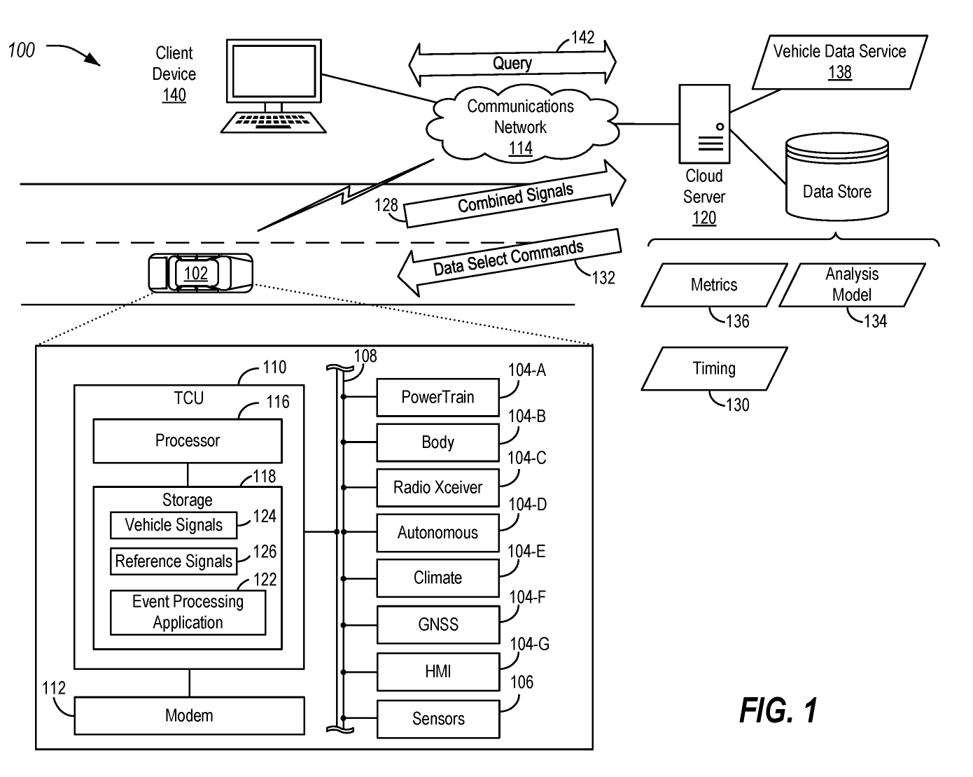

FIG. 1 illustrates an example system 100 for using identifying and addressing data spoofing in the collection and analysis of vehicle data. The system 100 includes one or more vehicles 102, where each vehicle 102 includes a plurality of controllers 104 and sensors 106. Each vehicle 102 also includes one or more vehicle buses 108 for communication between the controller 104, sensors 106, and a TCU 110. The TCU 110 includes or otherwise has access to a modem 112 configured to facilitate communication over a communication network 114. The TCU 110 may include a processor 116 and a storage 118. The TCU 110 may capture vehicle signals 124 and maintain them in the storage 118. The storage 118 may also maintain an event processing application 122 and reference signals 126 generated by the TCU 110. The event processing application 122 may compile the vehicle signals 124 and the reference signals 126 into combined signals 128 and may send the combined signals 128 to a cloud server 120. The cloud server 120 may also be configured to execute a vehicle data service 138 that uses one or more analysis models 134 to operate on the combined signals 128 to determine various metrics 136. In some cases, the vehicle data service 138 may send data select commands 132 to inform the TCU 110 how to combine the vehicle signals 124 and the reference signals 126 into the combined signals 128. The metrics 136 may also be provided to a client device 140 responsive to client queries 142, in an example, to facilitate quoting insurance rates for the vehicles 102 and/or for scheduling maintenance for the vehicles 102. It should be noted that the system 100 is only an example, and systems 100 with more, fewer, or different components may be used.

The vehicle 102 may be any various types of automobile, crossover utility vehicle (CUV), sport utility vehicle (SUV), truck, recreational vehicle, boat, plane or other mobile machine for transporting people or goods. Such vehicles 102 may be human-driven or autonomous. In many cases, the vehicle 102 may be powered by an engine. As another possibility, the vehicle 102 may be a battery electric vehicle (BEV) powered by one or more electric motors. As a further possibility, the vehicle 102 may be a hybrid electric vehicle (HEV) powered by both an engine and one or more electric motors, such as a series hybrid electric vehicle (SHEV), a parallel hybrid electrical vehicle (PHEV), or a parallel/series hybrid electric vehicle (PSHEV). Alternatively, the vehicle 102 may be an autonomous vehicle (AV). The level of automation may vary between variant levels of driver assistance technology to a fully automatic, driverless vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs).

The vehicle 102 may include a plurality of controllers 104 configured to perform and manage various vehicle 102 functions under the power of the vehicle battery and/or drivetrain. As depicted, the example vehicle controllers 104 are represented as discrete controllers 104 (i.e., controllers 104A through 104G). However, the vehicle controllers 104 may share physical hardware, firmware, and/or software, such that the functionality from multiple controllers 104 may be integrated into a single controller 104, and that the functionality of various such controllers 104 may be distributed across a plurality of controllers 104.

As some non-limiting vehicle controller 104 examples: a powertrain controller 104A may be configured to provide control of engine operating components (e.g., idle control components, fuel delivery components, emissions control components, etc.) and for monitoring status of such engine operating components (e.g., status of engine codes); a body controller 104B may be configured to manage various power control functions such as exterior lighting, interior lighting, keyless entry, remote start, and point of access status verification (e.g., closure status of the hood, doors and/or trunk of the vehicle 102); a radio transceiver controller 104C may be configured to communicate with key fobs, mobile devices, or other local vehicle 102 devices; an autonomous controller 104D may be configured to provide commands to control the powertrain, steering, or other aspects of the vehicle 102; a climate control management controller 104E may be configured to provide control of heating and cooling system components (e.g., compressor clutch, blower fan, temperature sensors, etc.); a GNSS controller 104F may be configured to provide vehicle location information; and a human-machine interface (HMI) controller 104G may be configured to receive user input via various buttons or other controls, as well as provide vehicle status information to a driver, such as fuel level information, engine operating temperature information, and current location of the vehicle 102.

The controllers 104 of the vehicle 102 may make use of various sensors 106 in order to receive information with respect to the surroundings of the vehicle 102. In an example, these sensors 106 may include one or more of cameras (e.g., advanced driver-assistance system (ADAS) cameras), ultrasonic sensors, radar systems, and/or lidar systems. Each controller 104 may process internal signals provided by corresponding sensors 106, e.g. body control modules may receive get brake sensors signals, vehicle network signals (from other controllers 104 and their sensors 106), and in some cases external sources of information including but not limited to weather data, traffic data, prior map information, etc. These external data sources may also be spoofed by a user to affect model results. As some other examples, driver state monitoring controllers 104 may utilize sensors 106 such as such as steering wheel torque sensors, capacitive sensors, driver state monitoring camera signals including eyes on road, etc..

One or more vehicle buses 108 may include various methods of communication available between the vehicle controllers 104, as well as between the TCU 110 and the vehicle controllers 104. As some non-limiting examples, the vehicle bus 108 may include one or more of a vehicle controller area network (CAN), an Ethernet network, and a media-oriented system transfer (MOST) network.

The TCU 110 may include network hardware configured to facilitate communication between the vehicle controllers 104 and with other devices of the system 100. For example, the TCU 110 may include or otherwise access a modem 112 configured to facilitate communication over a communication network 114. The TCU 110 may, accordingly, be configured to communicate over various protocols, such as with the communication network 114 over a network protocol (such as Uu). The TCU 110 may, additionally, be configured to communicate over a broadcast peer-to-peer protocol (such as PC5), to facilitate cellular vehicle-to-everything (C-V2X) communications with devices such as other vehicles 102. It should be noted that these protocols are merely examples, and different peer-to-peer and/or cellular technologies may be used.

The TCU 110 may include various types of computing apparatus in support of performance of the functions of the TCU 110 described herein. In an example, the TCU 110 may include one or more processors 116 configured to execute computer instructions, and a storage 118 medium on which the computer-executable instructions and/or data may be maintained. A computer-readable storage medium (also referred to as a processor-readable medium or storage 118) includes any non-transitory (e.g., tangible) medium that participates in providing data (e.g., instructions) that may be read by a computer (e.g., by the processor(s) 116). In general, the processor 116 receives instructions and/or data, e.g., from the storage 118, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, Java Script, Perl, etc.

The TCU 110 may be configured to include one or more interfaces from which information of the vehicle 102 may be sent and received. This information can be sensed, recorded, and sent to one or more cloud servers 120. In an example, similar to the TCU 110, the cloud server 120 may also include one or more processors (not shown) configured to execute computer instructions, and a storage medium (not shown) on which the computer-executable instructions and/or data may be maintained.

The event processing application 122 may be an application installed to the TCU 110 for use in performing one or more of the operations of the TCU 110 as discussed in detail herein. In an example, the management of the vehicle signals 124, reference signals 126, combined signals 128, etc., may be handled by an event processing application 122 executed by the TCU 110.

The TCU 110 may be configured to facilitate the collection of vehicle signals 124 from the vehicle controllers 104 connected to the one or more vehicle buses 108. These may include, for example, ADAS vehicle signals 124 generated by ADAS functions of the vehicle 102. While only a single vehicle bus 108 is illustrated, it should be noted that in many examples, multiple vehicle buses 108 are included, usually with a subset of the controllers 104 connected to each vehicle bus 108. Accordingly, to access a given controller 104, the TCU 110 may be configured to maintain a mapping of which vehicle buses 108 are connected to which controllers 104, and to access the corresponding vehicle bus 108 for a controller 104 when communication with that particular controller 104 is desired.

As used herein, vehicle signals 124 (e.g., ADAS signals and the like) may refer to various binary, multi-state, integer, float, and/or continuous parameters that may be generated or otherwise raised by the vehicle controller 104 and/or sensors 106. The vehicle signals 124 may include varying unit types, such as time series data of differing frequency and event streams, and/or differing object types such as float, array, matrices, nested data types, etc. As some non-limiting examples, the vehicle signals 124 may include one or more of: latitude, longitude, time, heading angle, speed, throttle position, brake status, steering angle, headlight status, wiper status, external temperature, turn signal status, ambient temperature or other weather conditions, alertness status, hands-off-wheel status, all-wheel drive (AWD) engaged status, front object detection, side object detection status, rear object detection status, etc.

The reference signals 126 may refer to simulated data that is generated by the TCU 110 and/or prerecorded vehicle signals 124, not data that is measured by the sensors 106 of the vehicle 102 during instant operation. In a simple example, the reference signals 126 may include predefined data that is provided when requested. However, such an approach may be easy to be spotted if the reference signals 126 data have enough repetition.

In another example, the reference signals 126 may be simulated by the TCU 110 based on predefined characteristics of the vehicle signals 124. For example, statistical properties such as mean, variance, and correlations, as well as temporal patterns like daily or seasonal variations and typical usage trends may be used to construct a model that generates synthetic data that closely mimics the statistical properties of the vehicle signals 124. Techniques like adding Gaussian or Poisson noise, leveraging autoregressive models or generative adversarial networks (GANs), and simulating vehicle states (e.g., idle, accelerating, cruising) may be employed to produce data sequences that align with real-world patterns. Random perturbations may be introduced in some examples, to mimic natural inconsistencies, and event injection may be used to replicate occasional outliers such as changes in speed, adding realism to the synthetic data. Environmental variables, such as pseudo-random temperature or road condition effects, may also be incorporated to further enhance the authenticity.

The combined signals 128 may refer to a collection of the vehicle signals 124 and the reference signals 126. In an example, the vehicle signals 124 and the reference signals 126 may be combined into the combined signals 128 based on a predefined timing 130 known or otherwise available to both the vehicle 102 and the cloud server 120. The predefined timing 130 may specify, for which durations, whether the vehicle signals 124 should be included in the combined signal 128 or instead whether the reference signal 126 should be included. In a simple example, the predefined timing 130 may include a first time period of a first fixed duration in which the vehicle signals 124 are included in the combined signals 128, followed by a second time period of a second fixed duration in which the reference signals 126 are included. The pattern may then be repeated.

In some examples, the TCU 110 may receive data select commands 132 from the cloud server 120. The data select commands 132 may be used to specify the predefined timing 130 to be used in generating the combined signals 128 from the vehicle signals 124 and the reference signals 126. In some examples, the data select commands 132 may further specify additional information, such as which of the vehicle signals 124 to include in the combined signals 128, and/or for which vehicle signals 124 to instead provide the reference signals 126 when generating the combined signals 128.

The analysis model 134 may be any of various machine learning models trained to determine metrics 136 based on the vehicle signals 124 (here the combined signals 128). In an example, an analysis model 134 may be configured to infer metrics 136 related to vehicle 102 based on a training of the analysis model 134 using combined signals 128 from vehicles 102 with known outcomes. In one example, an analysis model 134 may be trained on maintenance data for vehicles 102 based on vehicle signals 124 to allow the analysis model 134 to determine metrics 136 with respect to likely maintenance required by the vehicle 102. In another example, an analysis model 134 may be trained on insurance data for vehicles 102 based on vehicle signals 124 to allow the analysis model 134 to determine metrics 136 with respect to likely incidents that may occur due to how the vehicle 102 is being driven.

The system 100 may further include one or more client devices 140 configured to access the cloud server 120 over the communication network 114. Using the services of the vehicle data service 138 of the cloud server 120, the one or more client devices 140 may be configured to perform client queries 142 for the metrics 136 for various information, e.g., for preparation of insurance quotes for the vehicles 102 and/or for scheduling maintenance of the vehicles 102.

The cloud server 120 utilizes the vehicle data service 138 to generate metrics 136 using the combined signals 128. In an example, the vehicle data service 138 may utilize one or more analysis models 134. For instance, metrics 136 related to insurance may be generated using an insurance analysis model 134, and/or metrics 136 related to maintenance may be generated using a maintenance analysis model 134.

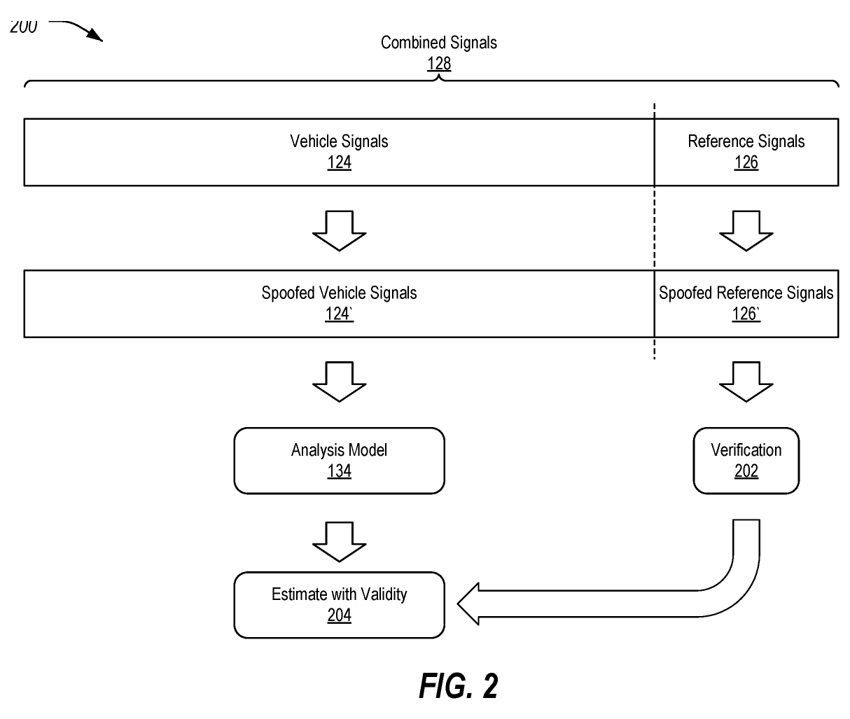

FIG. 2 illustrates an example data flow 200 for the operation of the system 100 to detect spoofed vehicle signals 124`. In the data flow 200, combined signals 128 are illustrated that are composed of vehicle signals 124 and reference signals 126. Additionally, combined signals 128 are illustrated that are composed of spoofed vehicle signals 124` and spoofed reference signals 126`. When the combined signals 128 are provided to the analysis models 134, metrics 136 may be inferred based on the training of the analysis models 134. However, when the combined signals 128` including spoofed data are provided to the analysis models 134, the metrics 136 that are produced may not be accurate.

Spoofed vehicle signals 124` may enter the system 100 at various points. In an example, data traversing the vehicle buses 108 may be adjusted (e.g., changed, hidden, added to, and/or corrupted). This may be done, for example, by a controller 104 programmed to make changes to the vehicle signals 124, e.g., to hide poor driving. In another example, an additional device may be attached to the vehicle bus 108, such as to a diagnostic port of the vehicle 102, for the purpose of adjusted the vehicle signals 124. In yet another example, the vehicle signals 124 may be spoofed by the TCU 110 itself. For example, custom software may be installed to the TCU 110 to make adjustments to the vehicle signals 124. In still another example, the vehicle signals 124 may be adjusted as they traverse the communication network 114, such as by being adjusted by a proxy server between the vehicle 102 and the cloud server 120.

To detect these types of spoofing approaches, a verification 202 may be performed to ensure the integrity of the combined signals 128. This verification 202 may be performed in various ways. Based on the verification 202, a validity estimate 204 may be determined, which may be used to determine whether the combined signals 128 are valid or are spoofed combined signals 128`.

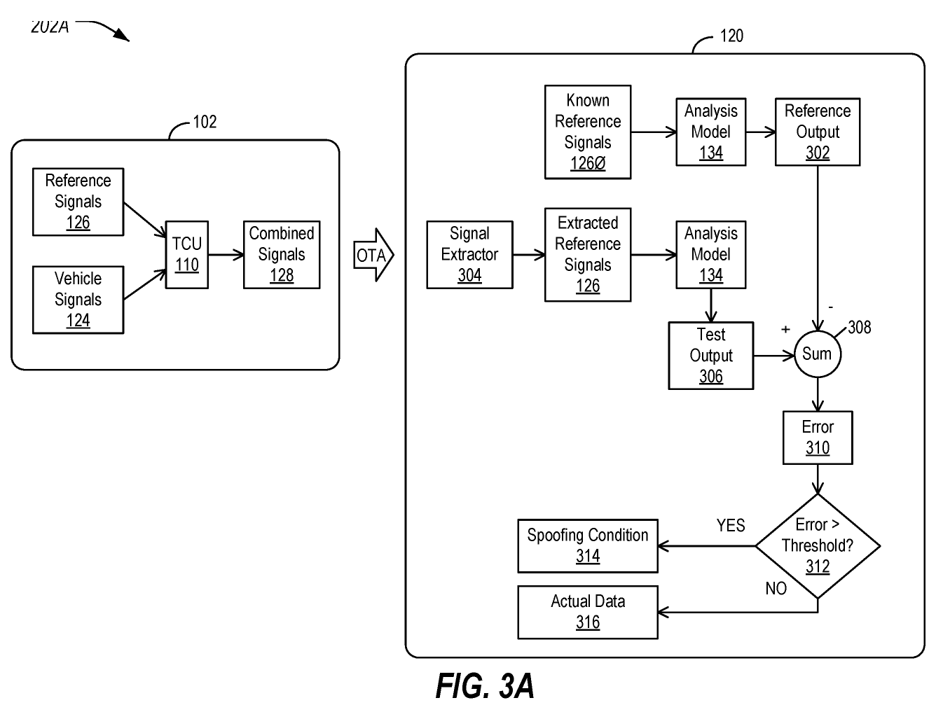

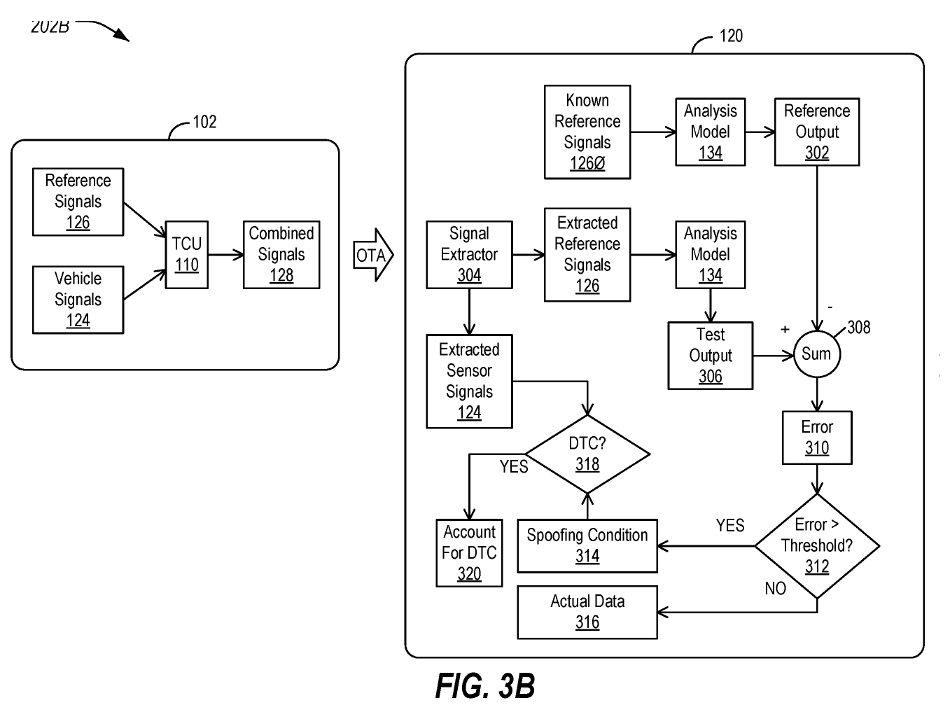

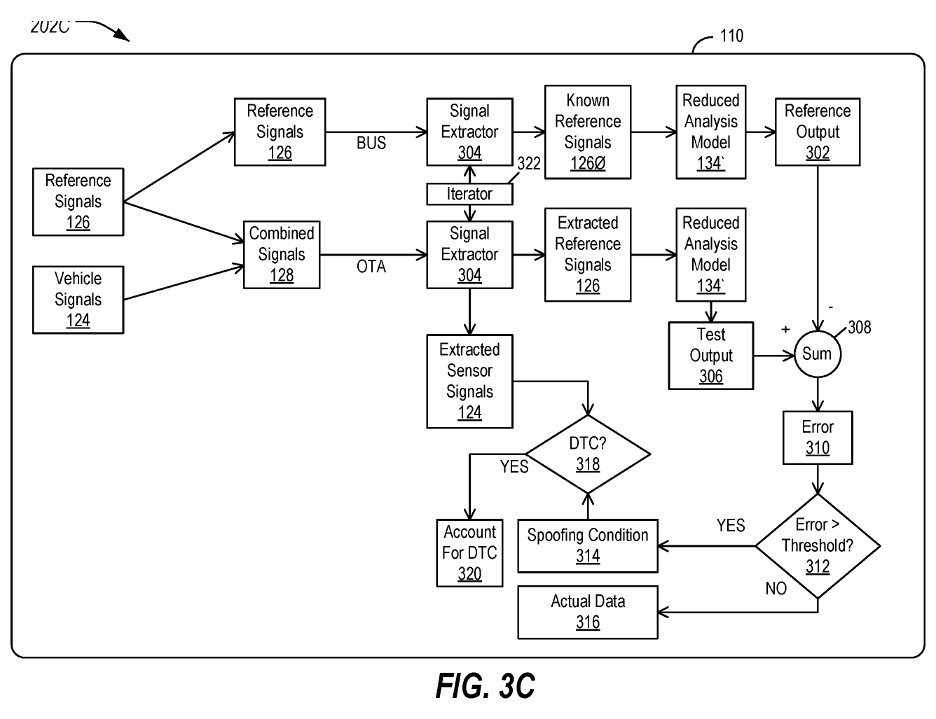

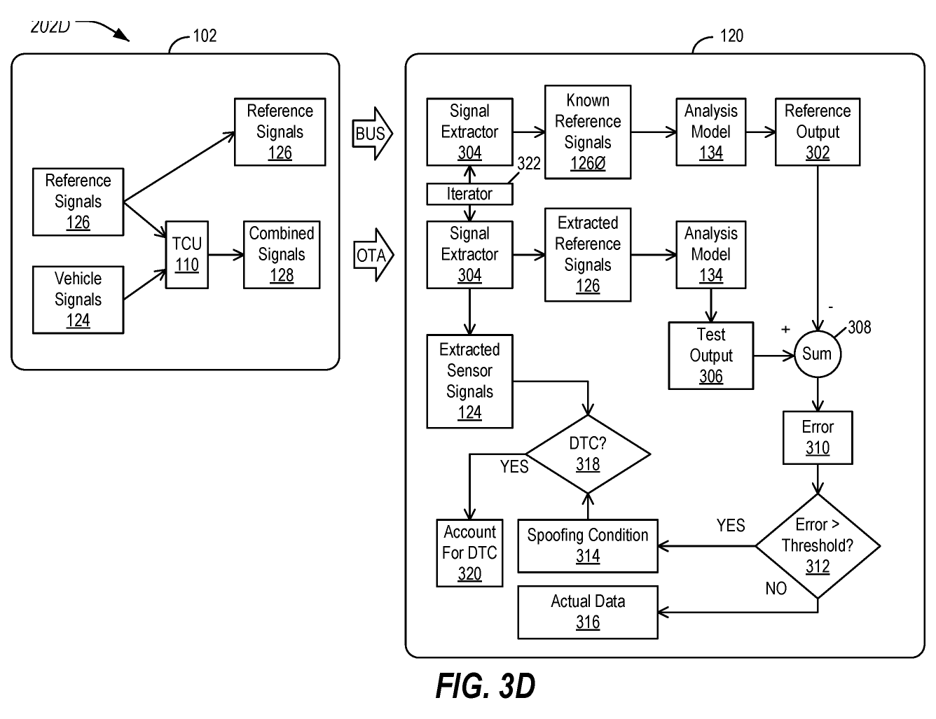

FIG. 3A illustrates an example of a first type of verification 202A of the combined signals 128 that may be performed by the cloud server 120. As shown, the vehicle 102 utilizes the TCU 110 to combine the vehicle signals 124 and the reference signals 126, which are then sent over the communication networks 114 to the cloud server 120 for analysis.

The cloud server 120, likewise, performs various operations of the verification 202 based on the received combined signals 128. As shown, the cloud server 120 may utilize one or more of the analysis models 134 to generate a reference output 302 from known reference signals 126Ø (the Ø symbol is used herein to refer to the reference). In some examples, this generation of the reference output 302 is performed ahead of time, such that the reference output 302 is stored for later use.

The cloud server 120 is also configured to, responsive to receipt of the combined signals 128 from the vehicles 102, utilize a signal extractor 304 to retrieve the reference signals 126 portion of the combined signals 128 from the received combined signals 128. This may be accomplished, for example, by using the same predefined timing 130 known or otherwise available to the vehicle 102 for generating the combined signals 128. In such an approach, the signal extractor 304 retrieves the periods of time of data from the combined signal 128 that should correspond to the reference signals 126.

The cloud server 120 further uses the one or more of the analysis models 134 to generate a test output 306. The test output 306 is therefore generated in the same approach as the reference output 302 is generated. Accordingly, as comparable data processing is performed, the resultant reference output 302 and test output 306 should therefore also too be comparable.

As shown, in one simple example an adder 308 is configured to subtract the test output 306 from the reference output 302 and provide a result of that operation. For instance, the reference output 302 may be a vector and the test output 306 may also be a vector of the same size, which may be subtracted from one another element-by-element to produce an error signal 310. This error signal 310 may relate to a measure of the difference between the reference output 302 and the test output 306. In another example, the adder 308 may combine the vector differences into a single scalar quantity reflective of an overall error signal 310.

An error comparison 312 may be used to compare the error signal 310 to a threshold level of error, such that if the error signal 310 exceeds the threshold level, then a spoofing condition 314 is detected. If the error signal 310 is within the threshold level of error, then an actual data condition 316 is detected. Based on this verification 202 of the reference signals 126 in the combined signals 128, the cloud server 120 may infer the validity estimate 204 of the reliability of using the vehicle signals 124 portion of the combined signals 128. For instance, if the reference signals 126 are deemed to involve a likely spoofing condition 314, then metrics 136 that are based on the vehicle signals 124 portion of the combined signals 128 are likely also spoofed and should have a low validity estimate 204.

FIG. 3B illustrates an example of a second type of verification 202B of the combined signals 128 that may be performed by the cloud server 120. As shown, the second type of verification 202 further accounts for the possible presence of diagnostic trouble codes (DTCs) as a reason for the error signal 310 as opposed to being a spoofing condition 314. Some issues might raise DTCs, such as a disconnected camera or a GNSS antenna and/or controller being disconnected. DID values may also be of interest depending on their values and what is potentially being spoofed. As shown, the signal extractor 304 may further provide extracted vehicle signals 124, in addition to providing the extracted reference signals 126. This may be performed by using the information from the combined signals 128 that is not the extracted reference signals 126 as being the extracted vehicle signals 124.

The cloud server 120 may then analyze the reference signals 126 to identify whether the vehicle signals 124 include DTCs. If so, then a detected spoofing condition 314 may be mitigated into a condition that accounts for a DTC 320, e.g., by lowering the likelihood of a spoofing condition 314, and/or my raising an alert to repair the vehicle 102 before utilizing the combined signals 128 for determining metrics 136 via the analysis models 134. Accordingly, this allows the system 100 to separate fault detection of potential issues with the sensors 106 themselves from data spoofing of the data captured by the sensors 106.

FIG. 3C illustrates an example of a third type of verification 202C of the combined signals 128 that may be performed locally on the vehicle 102 using an iterator 322 component. As compared to the verification 202A or the verification 202B, the verification 202C may be performed local to the vehicle 102. As shown, the verification 202C is performed by the TCU 110, but in other examples some or all of the verification 202C could be performed using other controllers 104 of the vehicle 102.

In such an example, a reduced analysis model 134` may be used for the computation of the reference output 302 and the test output 306. This reduced analysis model 134` may utilize fewer parameters and/or otherwise may have lower computational complexity to run inference operations, thereby allowing the reduced analysis model 134` to be executable the controllers 104 of the vehicle 102.

Moreover, in this example the known reference signals 126Ø may be the reference signals 126 as received via the vehicle bus 108, as opposed to the information provided by the TCU 110. This may allow for the avoidance of potential data spoofing operations that are performed onboard the vehicle 102 by the TCU 110.

Additionally, the error comparison 312 may be to compare the reference output 302 and the test output 306 of the analysis model 134 by replacing individual vehicle signals 124 from the TCU 110 combined signals 128 with the reference signals 126 from the vehicle bus 108. For example, an iterator 322 component may be used to control the signal extractor 304 to selectively replace and/or mask out individual vehicle signals 124 in the vehicle bus 108 data and the extracted reference signals 126. By comparing without each of the vehicle signals 124 in turn, the system 100 may be able to identify which specific vehicle signals 124 may have been compromised.

FIG. 3D illustrates an example of a fourth type of verification 202D of the combined signals 128 that may be performed by the cloud server 120 using the iterator 322 component. Similar to the verification 202C, the iterator 322 may be used to compare reference signals 126 from the vehicle buses 108 (e.g., received via a diagnostic port or otherwise recorded for analysis) with reference signals 126 from the TCU 110 (e.g., received over-the-air (OTA) via the communication network 114). In this example the full analysis models 134 may be used. Similar to the verification 202C, anomalous vehicle signals 124 between the reference outputs 302 and the test outputs 306 may be used to flag corrupted and/or spoofed vehicle signals 124.

If such corrupted and/or spoofed vehicle signals 124 are detected, the cloud server 120 may send a data select command 132 to the vehicle 102 to reconfigure the vehicle 102 to no longer use the corrupted and/or spoofed vehicle signals 124. This may allow for an increase in the reliability of metrics 136 computed using the combined signals 128 of the vehicle 102, despite the corrupted and/or spoofed vehicle signals 124.

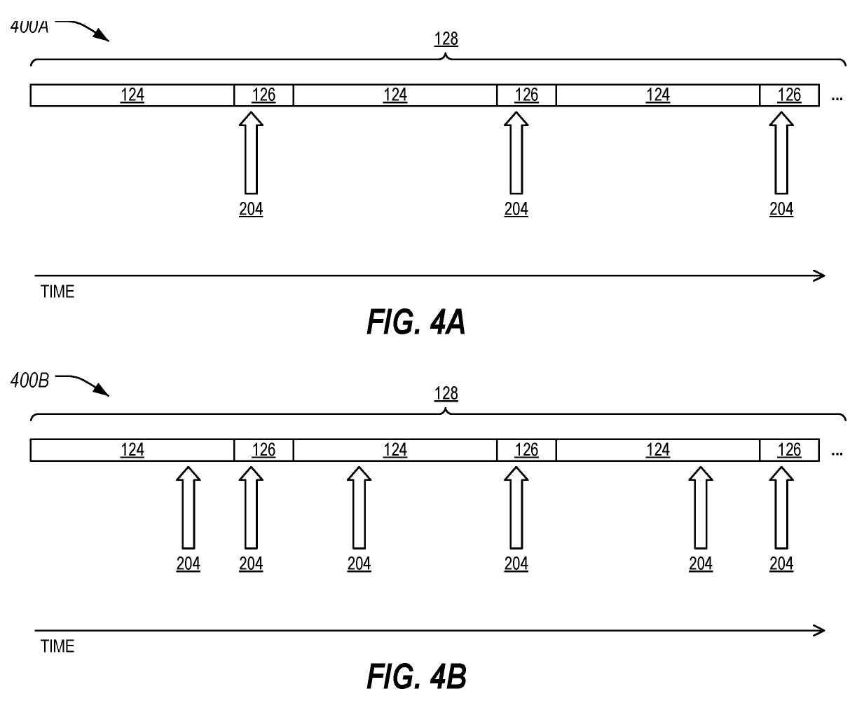

FIG. 4A-4B illustrates examples 400A, 400B of performing the verifications 202 over time to determine validity estimates 204 over time. This may be useful, because a user may temporarily alter the signaling of the vehicle 102 to mask periods of poor driving usage or behavior. For example, a user may bring their vehicle 102 to a local race track on weekends where upon they deactivate the sensors 106 or modem 112 of the TCU 110. Alternatively, a more sophisticated intermittent approach may be implemented to hide driving maneuvers in which there is a change in speed greater than some threshold value. In another example, spoofing may be used to hide a third-party semi-autonomous driving add-on system.

As shown in FIG. 4A, verifications 202 of the reference signals 126 may be performed periodically based on the cadence of the generation of the combined signals 128. For example, since the predefined timing 130 of the occurrence of the reference signal 126 is known by both the vehicle 102 and the cloud server 120, the cloud server 120 may periodically perform the verification 202 to see at which points in time the reference signal 126 show a good validity estimate 204 and at which other points in time the reference signal 126 shows a poor validity estimate 204. Based on this information the cloud servers 120 may conclude that the vehicle signals 124 received around the time of the likely invalid reference signals 126 are also likely invalid.

As shown in FIG. 4B, verifications 202 of the vehicle signals 124 may additionally be performed, also based on the cadence of the generation of the combined signals 128. Using the same predefined timing 130, the cloud server 120 may also make determinations about the validity of the vehicle signals 124 portion of the combined signals 128. For example, aspects of the presence or absence of signals in the vehicle signals 124 portions of the combined signals 128 may also be used to determine whether the vehicle signals 124 are likely valid or invalid. For instance, if certain data elements are missing from the vehicle signals 124 without a DTC 320, then it can be inferred that there may be a spoofing event occurring.

The validity estimate 204 results of the verifications 202 may be used to predict whether a modem 112 or other loss of communication is related to a spoofing attempt or to a technical failure of the communication network 114. If the disconnection occurs intermittently (e.g., to hide an hour of track racing or a harsh driving events), the metrics 136 before and after the event may be used to predict aspects of the occurrence during the time of no data. For example, the total mileage usage and/or outage time may be used to infer predict average speed, which may or may not additionally be compared to local driving region speed limits before and after the outage period. In another example, outlier detection, machine learning (ML), and/or statistical data analysis of the time and/or duration of the loss of communication may be used.

Variations on the disclosed approaches are possible. In an example, the system 100 may alter or vary the reference signals 126 passed through communication networks 114 to the cloud server 120 responsive to characterizing a spoofing device (e.g., reverse-engineering the spoofing device and sending data select commands 132 to the vehicles 102 to change the functionality to overcome the spoofing). For example, if it is detected that a spoofing device only activates for adjusting vehicle speeds above a certain speed limit, then the vehicle 102 may be instructed to instead send a specific other speed value within the limit to indicate an overage of speed. In another example, cryptographic approaches may be applied to the combined signal 128 to avoid alterations of the combined signal 128.

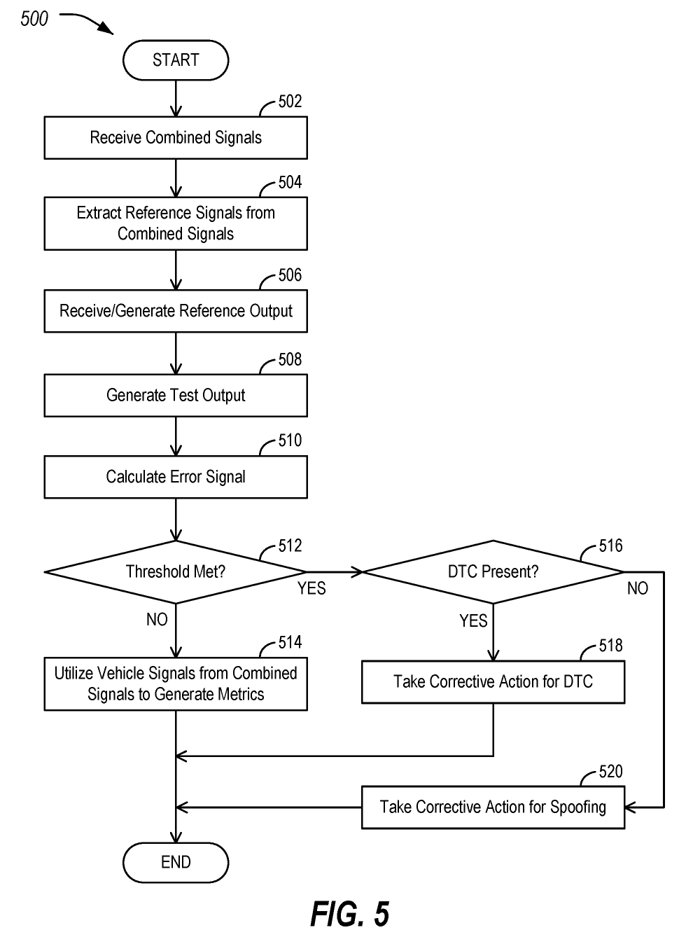

FIG. 5 illustrates an example process 500 for validating the integrity of vehicle signals 124 using the cloud server 120. In an example, the process 500 may be performed by the cloud server 120 in the context of the system 100.

At operation 502, the cloud server 120 receives combined signals 128 from a telematics control unit (TCU 110) of a vehicle 102 over a wide-area communication network 114. The combined signals 128 include sensor 106 signals collected from vehicle 102 controllers 104 and reference signals 126 generated by the TCU 110 according to a predefined timing 130 pattern shared between the TCU 110 and the cloud server 120.

At operation 504, the cloud server 120 extracts the reference signals 126 from the received combined signals 128 using the predefined timing 130 pattern. The extracted reference signals 126 correspond to periods where synthetic or predefined data was injected into the combined signals 128 by the TCU 110.

At operation 506, the cloud server 120 retrieves or generates a reference output 302 by processing predefined reference signals 126 using an analysis model 134. If precomputed reference outputs 302 exist for the predefined reference signals 126, the cloud server 120 may instead retrieve the predefined reference signals 126, e.g., from storage 118 of the cloud server 120, to expedite the comparison.

At operation 508, the cloud server 120 generates test output 306. In an example, the cloud server 120 performs inference on the extracted reference signals 126 using the same analysis model 134 as used for determination of the reference output 302. This ensures that the test output 306 is computed under the same conditions as the reference output 302.

At operation 510, the cloud server 120 calculates an error signal 310 by comparing the reference output 302 and the test output 306. The error signal 310 may be computed as a subtraction of the vector representations of the outputs, yielding a scalar value. In some examples, the cloud server 120 iteratively replaces individual sensor 106 signals in the combined signals 128 during the generation of the test output 306. By comparing the test outputs 306 for each iteration, the cloud server 120 may identify specific corrupted or spoofed signals.

At operation 512, the cloud server 120 determines whether the error signal 310 meets a predefined threshold. If the error signal 310 does not exceed the threshold, the server determines that the vehicle signals 124 in the combined signals 128 are likely valid and therefore control proceeds to operation 514.

At operation 514, the cloud server 120 utilizes the vehicle signals 124 from the combined signals 128 for the generation of metrics 136 using the analysis models 134. In an example, the cloud server 120 may utilize a UBI analysis model 134 to predict UBI metrics 136 for determining of UBI. In another example, the cloud server 120 may utilize a maintenance analysis model 134 to predict maintenance metrics 136 for determining when to perform maintenance on the vehicle 102. After operation 514, the process 500 ends.

If, however, from operation 512, if the error signal 310 exceeds the threshold, the server determines that a spoofing condition 314 may exist. If so, control passes to operation 516.

At operation 516, the cloud server 120 analyzes DTCs 320 extracted from the combined signals 128. This analysis may be optional, but may be performed to differentiate between a spoofing condition 314 and a potential sensor 106 issue. In an example, the cloud server 120 analyzes the vehicle signals 124 of the combined signals 128 to locate any DTCs. If DTCs are indicated, control passes to operation 518. Otherwise, control proceeds to operation 520.

At operation 518, the cloud server 120 takes corrective action based on occurrence of the DTC. In an example, the cloud server 120 may send a message to the vehicle 102, a fleet owner of the vehicle 102, an operator of the vehicle 102, etc., indicating that the vehicle 102 may require servicing. In another example, the cloud server 120 may schedule the vehicle 102 for service. In yet another example, the cloud server 120 transmits a data select command 132 to the TCU 110, to specify a reconfiguration of the TCU 110 to exclude the vehicle signals 124 that may be affected by the DTC 320. After operation 518, the process 500 ends.

At operation 520, the cloud server 120 takes corrective action based on occurrence of the spoofing condition 314. In an example, the cloud server 120 transmits a data select command 132 to the TCU 110. The data select command 132 may specify a reconfiguration of the TCU 110 to exclude identified vehicle signals 124 subsequent combined signals 128 that are identified as being spoofed. After operation 520, the process 500 ends.

Variations on the process 500 are possible. For instance, the process 500 may be iteratively performed over time to perform periodic verifications 202 of the reference signals 126. This iterative approach may be used to detect intermittent spoofing conditions 314, such as temporary alterations during specific driving scenarios.

As another possibility, the cloud server 120 may implement remote server reference signal request logic to request the predefined reference signals 126 from the vehicle 102. The request may be received by the TCU 110, which may respond with the predefined reference signals 126. Such an approach may allow the cloud server 120 to stay current with the latest predefined reference signals 126 of the vehicle 102.

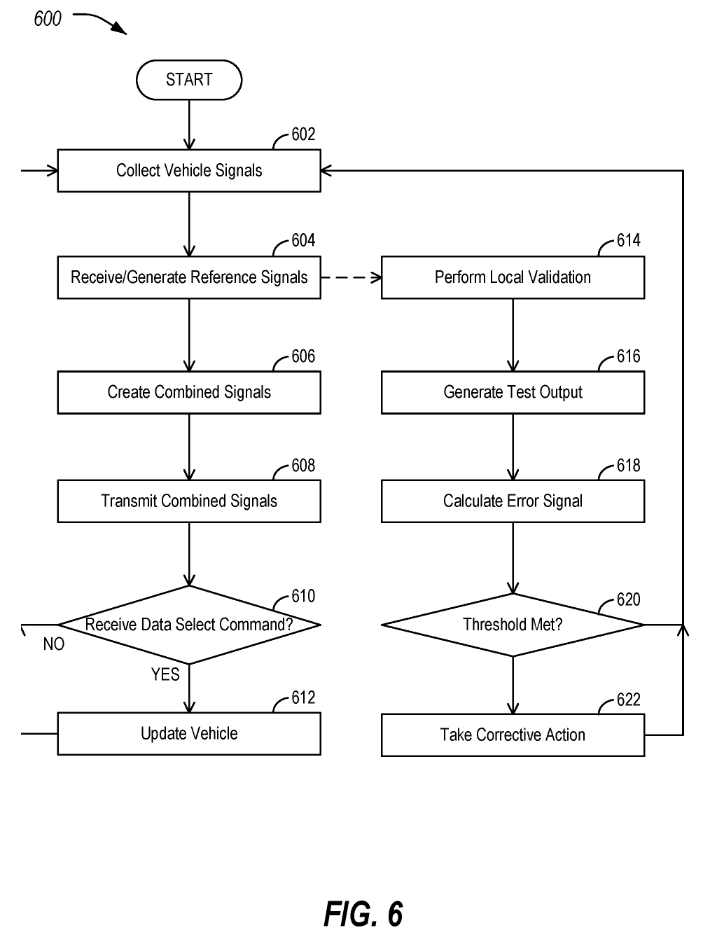

FIG. 6 illustrates an example process 600 for validating the integrity of vehicle signals 124 by the vehicle 102. In an example, the process 500 may be performed by the vehicle 102in the context of the system 100.

At operation 602, the vehicle 102 collects sensor 106 signals from one or more controllers 104 of the vehicle 102 and/or one or more sensors 106 of the vehicle 102. This collection may be performed over the vehicle buses 108, in an example. For instance, the TCU 110 may maintains a mapping of controllers 104 and associated vehicle buses 108, allowing targeted retrieval of signals from specific controllers 104 as required.

At operation 604, the vehicle 102 receives or generates reference signals 126 using a statistical model. In an example, the vehicle 102 may retrieve the reference signals 126 from a storage for the vehicle 102 for use. In another example, the vehicle 102 may utilize a statistical model incorporating predefined characteristics of the sensor 106 signals, such as temporal patterns (e.g., daily usage patterns) and environmental variations (e.g., temperature fluctuations or road conditions), to construct plausible reference signals 126.

At operation 606, the vehicle 102 combines the collected sensor 106 signals and generated reference signals 126 into combined signals 128. This may be performed based on a predefined timing 130 pattern shared with the cloud server 120, specifying intervals during which reference signals 126 are included in the combined signal 128 and intervals where vehicle signals 124 are included in the combined signals 128.

At operation 608, the vehicle 102 transmits the combined signals 128 to the cloud server 120. In many examples, this transfer may occur over the wide-area communication network 114. In some examples, the transfer may occur in whole or in part over a local diagnostic connection between the vehicle 102 and the cloud server 120. This transfer may be received, for example, at operation 502 of the process 500.

At operation 610, the vehicle 102 determines whether a data select command 132 was received from the cloud server 120. In an example, the data select command 132 may have been sent due to operations 518 or 520 of the process 500. If a data select command 132 is received, control passes to operation 612. If not control returns to operation 602.

At operation 612, the vehicle 102 updates based on the data select command 132. Fo example, the update may including adjustments to the signal generation or transmission process 500 that are specified by the data select command 132. These may include, as some examples, excluding specific spoofed signals or modifying the predefined timing 130 pattern for future combined signals 128. After operation 612, the process 600 returns to operation 602. This may include, for example, the vehicle 102 continuing along the process 600 to collect and transmit additional combined signals 128 to be sent based on the adjustments received in the data select command 132.

At operation 614, from operation 604, the vehicle 102 performs a local verification 202, in addition to or instead of the verification 202 performed by the cloud server 120. This local verification 202 may involve using a reduced analysis model 134 to process the combined signals 128 locally, generating an error signal 310 to detect potential spoofing conditions 314 without using the cloud server 120. For instance, the vehicle 102 may maintain or compute local reference output 302 using the reduced analysis model 134.

At operation 616, the vehicle 102 generates test output 306. In an example, the vehicle 102 performs inference on the local vehicle signals 124 using the same reduced analysis model 134 as used for determination of the local reference output 302. This ensures that the test output 306 is computed under the same conditions as the reference output 302.

At operation 618, similar to as performed at operation 510 by the cloud server 120, the vehicle 102 calculates an error signal 310 by comparing the local reference output 302 and the local test output 306.

At operation 620, similar to as performed at operation 512 by the cloud server 120, the cloud server 120 determines whether the error signal 310 meets a predefined threshold. If the error signal 310 does not exceed the threshold, the server determines that the vehicle signals 124 in the combined signals 128 are likely valid and therefore control proceeds to operation 602. Otherwise, control proceeds to operation 622 to take corrective action.

At operation 622, one or more corrective actions may be performed, including those discussed for operations 518 and 520 of the process 500. As some examples, the vehicle 102 may send a message to the vehicle 102, a fleet owner of the vehicle 102, an operator of the vehicle 102, etc., indicating that the vehicle 102 may require servicing. In another example, the vehicle 102 may schedule the vehicle 102 for service. In yet another example, the vehicle 102 locally defines and implements a data select command 132 to the TCU 110, to specify a reconfiguration of the TCU 110 to exclude the vehicle signals 124 that may be affected by a DTC 320 detected in the vehicle signals 124. After operation 622, control returns to operation 602.

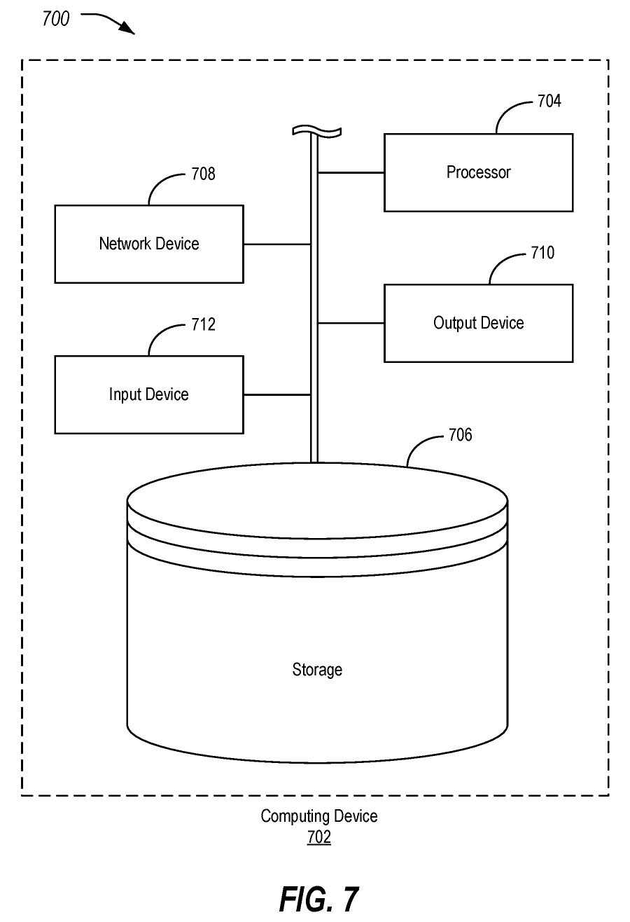

FIG. 7 illustrates an example computing device 702 for using combined signals 128 for determining vehicle metrics 136. Referring to FIG. 7, and with reference to FIGS. 1-6, the vehicle 102, controllers 104, sensors 106, TCU 110, and cloud server 120 may be examples of such computing devices 702. Computing devices 702 generally include computer-executable instructions, such as those of the vehicle data service 138 and the event processing application 122, where the instructions may be executable by one or more computing devices 702. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as vehicle signals 124, reference signals 126, combined signals 128, predefined timings 130, data select commands 132, analysis models 134, metrics 136, the vehicle data service 138, etc., may be stored and transmitted using a variety of computer-readable media.

As shown, the computing device 702 may include a processor 704 that is operatively connected to a storage 706, a network device 708, an output device 710, and an input device 712. It should be noted that this is merely an example, and computing devices 702 with more, fewer, or different components may be used.

The processor 704 may include one or more integrated circuits that implement the functionality of a central processing unit (CPU) and/or graphics processing unit (GPU). In some examples, the processors 704 are a system on a chip (SoC) that integrates the functionality of the CPU and GPU. The SoC may optionally include other components such as, for example, the storage 706 and the network device 708 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 704 executes stored program instructions that are retrieved from the storage 706. The stored program instructions, accordingly, include software that controls the operation of the processors 704 to perform the operations described herein. The storage 706 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 710. The output device 710 may include a graphical or visual display device, such as an electronic display screen, projector, printer, or any other suitable device that reproduces a graphical display. As another example, the output device 710 may include an audio device, such as a loudspeaker or headphone. As yet a further example, the output device 710 may include a tactile device, such as a mechanically raiseable device that may, in an example, be configured to display braille or another physical output that may be touched to provide information to a user.

The input device 712 may include any of various devices that enable the computing device 702 to receive control input from users. Examples of suitable input devices 712 that receive human interface inputs may include keyboards, mice, trackballs, touchscreens, microphones, graphics tablets, and the like.

The network devices 708 may each include any of various devices that enable the described components to send and/or receive data from external devices over networks. Examples of suitable network devices 708 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments may occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for validating vehicle signal integrity using a cloud server, comprising:
receiving, from a telematics control unit (TCU) of a vehicle, combined signals comprising sensor signals and reference signals;
extracting the reference signals from the combined signals based on a predefined timing pattern known to the server;
generating a reference output by processing predefined reference signals using an analysis model;
generating a test output by processing the extracted reference signals using the analysis model;
calculating an error signal as a difference between the reference output and the test output;
comparing the error signal to a predefined threshold to determine whether a spoofing condition exists; and
transmitting a data select command to the vehicle responsive to determining the spoofing condition to mitigate unreliable signals.

2. The method of claim 1, further comprising precomputing and storing the reference output for subsequent comparison.

3. The method of claim 1, wherein the predefined reference signals are generated using a statistical model incorporating predefined characteristics of the sensor signals, including temporal patterns and/or environmental variations of the sensor signals.

4. The method of claim 1, wherein the combined signals are received wirelessly over a wide-area communication network, and the predefined reference signals are received locally over a diagnostic interface between the cloud server and the vehicle.

5. The method of claim 1, further comprising analyzing diagnostic trouble codes (DTCs) extracted from the combined signals to differentiate between the spoofing condition and a sensor issue.

6. The method of claim 1, further comprising performing iteratively replacing individual sensor signals in the combined signals when generating the test output to identify specific corrupted signals.

7. The method of claim 1, wherein transmitting the data select command includes reconfiguring the TCU to exclude identified spoofed signals from subsequent combined signals.

8. The method of claim 1, further comprising generating validity estimates over time based on periodic verification of the predefined reference signals to detect intermittent spoofing conditions.

9. The method of claim 1, wherein the reference output and the test output are vector representations, and the error signal is a subtraction of the vector representations resulting in a scalar output to compare to a scalar predefined threshold.

10. The method of claim 1, wherein the analysis model is one or more of:
a usage-based insurance (UBI) analysis model configured to predict UBI metrics for determining of UBI; or
a maintenance analysis model configured to predict maintenance metrics for determining when to perform vehicle maintenance.

11. A vehicle comprising:
one or more vehicle controllers and sensors; and
one or more processors configured to
collect sensor signals from the one or more vehicle controllers and sensors via a vehicle bus of the vehicle,
combine the sensor signals and reference signals into first combined signals based on a predefined timing pattern,
transmit the combined signals to a cloud server over a communication network,
receive a data select command from the cloud server specifying adjustments to the combined signals, and
collect second combined signals to be sent subsequent to the first combined signals, based on the adjustments received in the data select command.

12. The vehicle of claim 11, wherein the reference signals are generated using a statistical model incorporating predefined characteristics of the sensor signals, including temporal patterns and/or environmental variations of the sensor signals.

13. The vehicle of claim 11, wherein the one or more processors are further configured to perform a local verification of the first combined signals using a reduced analysis model to generate an error signal indicating potential spoofing conditions.

14. The vehicle of claim 13, wherein performing the local verification includes iteratively replacing individual sensor signals with the reference signals to identify specific corrupted signals.

15. The vehicle of claim 11, wherein to collect the sensor signals includes to maintain a mapping of controllers and associated vehicle buses to retrieve the sensor signals from the one or more vehicle controllers and sensors.

16. The vehicle of claim 11, wherein the one or more processors are further configured to encrypt the first combined signals before transmission to ensure data integrity over the communication network.

17. A cloud server for validating vehicle signal integrity, comprising:
a storage configured to maintain predefined reference signals and a predefined timing pattern; and
one or more processors configured to:
receive, from a vehicle, combined signals comprising sensor signals and test reference signals,
extract the test reference signals from the combined signals based on the predefined timing pattern,
generate a reference output by processing the predefined reference signals using an analysis model,
generate a test output by processing the test reference signals using the analysis model,
calculate an error signal as a difference between the reference output and the test output,
compare the error signal to a predefined threshold to determine whether a spoofing condition exists, and
transmit a data select command to the vehicle responsive to determining the spoofing condition to mitigate unreliable signals.

18. The cloud server of claim 17, wherein the one or more processors are further configured to analyze DTCs extracted from the combined signals to differentiate between the spoofing condition and a sensor issue.

19. The cloud server of claim 17, wherein the one or more processors are further configured to perform iteratively replacing individual sensor signals in the combined signals when generating the test output to identify specific corrupted signals.

20. The cloud server of claim 17, wherein the one or more processors are further configured to specify, in the data select command, a reconfiguration of the vehicle to exclude identified spoofed signals from subsequent combined signals.

21. The cloud server of claim 17, wherein the one or more processors are further configured to generate validity estimates over time based on periodic verification of the predefined reference signals to detect intermittent spoofing conditions.
